(19) United States
(12) Patent Application Publication
(10) Pub. No.: US 2024/0372210 A1
(43) Pub. Date: Nov. 7, 2024

(54) Housing Part for Venting Gas From a Storage Cell of an Energy Store

(71) Applicant: Bayerische Motoren Werke Aktiengesellschaft, Muenchen (DE)

(72) Inventors: Franz FUCHS, Muenchen (DE); Daniel LOOS, Unterschleissheim (DE); Georg VOELKER, Unterschleissheim (DE); Matthias WAGNER, Muenchen (DE)

(21) Appl. No.: 18/573,472

(22) PCT Filed: Jun. 8, 2022
(86) PCT No.: PCT/EP2022/065488

§ 371 Date: Dec. 22, 2023

(30) Foreign Application Priority Data
Jun. 24, 2021 (DE) 10 2021 116 353.6

(51) Int. Cl. H01M 50/358; H01M 50/213; H01M 50/342; H01M 50/367

(52) U.S. Cl. CPC H01M 50/358; H01M 50/213; H01M 50/3425; H01M 50/367; H01M 2200/20; H01M 2220/20

(57) ABSTRACT

A housing part for an electrical energy store which has a plurality of storage cells disposed next to each other in such a way that gas venting valves of the plurality of storage cells are located on a common side includes a gas venting channel, which is designed to conduct gas to a gas venting valve of the energy store. The housing part also includes a shielding device, which is designed to cover the common side of the plurality of storage cells and thus to shield the common side of the plurality of storage cells from gas in the gas venting channel. The shielding device is also designed such that gas which exits through the gas venting valve of a first storage cell of the plurality of storage cells causes a locally limited opening in the shielding device, through which the gas from the first storage cell can pass into the gas venting channel. The shielding device is designed such that the one or more other storage cells of the plurality of storage cells are shielded from the gas from the first storage cell by the shielding device even when the locally limited opening is present.

### BACKGROUND AND SUMMARY

The invention relates to a housing part which permits reliable and safe degassing of a storage cell of an electrical energy store.

An at least partially electrically driven vehicle has at least one electrical energy store with a multiplicity of storage cells, e.g. round cells or prismatic cells. The individual storage cells are electrically conductively connected to one another via a cell contacting system in order to provide an electrical energy store with a specific nominal voltage and a specific nominal storage capacity. Furthermore, the individual storage cells can be adhesively bonded to one another in order to provide an electrical energy store with a fixed structure.

In the event of a short circuit inside a storage cell of the energy store, an exothermic reaction may occur in this storage cell in which hot gas containing particles arises. The hot gas containing particles can be conducted out of the interior of the storage cell into the installation space of the energy store via an emergency valve of the storage cell. In the installation space of the energy store, in particular in the interior of the housing of the energy store, the gas can pass via air gaps between the storage cells to an emergency degassing valve of the energy store (through which the gas passes into the environment). In the process, the other storage cells may be heated by the gas, which may lead to a loading for the other storage cells. Furthermore, the entrained (electrically conductive) particles may lead to an increased risk of short circuits between adjacent storage cells.

The present document deals with the technical object of enabling gas to be conducted particularly efficiently, gently and safely out of a storage cell of an electrical energy store.

The object is achieved by the independent claim. Advantageous embodiments are described, inter alia, in the dependent claims. Attention is drawn to the fact that additional features of a patent claim dependent on an independent patent claim, without the features of the independent patent claim or only in combination with a subset of the features of the independent patent claim, can form a separate invention which is independent of the combination of all the features of the independent patent claim and can be made the subject matter of an independent claim, a divisional application or a subsequent application. This applies in the same way to technical teachings described in the description which can form an invention independent of the features of the independent patent claims.

According to one aspect, a housing part for an electrical energy store is described. The energy store can be configured for a nominal voltage of 300V or more and/or for a nominal storage capacity of 10 kWh or more. The energy store can be designed, for example, as a high voltage store for an electrically driven motor vehicle.

The electrical energy store comprises a plurality of storage cells which are arranged next to one another in such a manner that degassing valves of the plurality of storage cells are arranged on a common side. The individual degassing valves can each be arranged on an end face of the respective storage cells. The end faces together with the degassing valves can therefore be arranged on a common side of the housing of the energy store (e.g. on the underside of the housing).

The individual storage cells can be, for example, round cells (with a circular end face) or prismatic cells (with a rectangular end face). The storage cells are preferably arranged next to one another as tightly packed as possible. For example, the storage cells (in particular circular-cylindrical round cells) can be arranged in accordance with a honeycomb mesh structure, e.g. in such a manner that the longitudinal axes of the storage cells of each subgroup of in each case three storage cells in each case form an isosceles triangle (within a plane which is perpendicular to the longitudinal axes).

The energy store can have, for example, N=50 or more, or N=100 or more, or N=1000 or more storage cells. The individual storage cells can each have one or more contact points (e.g. an electrically positive and/or an electrically negative contact point) on a first end face, via which the individual storage cells are electrically conductively contacted. The degassing valves can each be arranged on the opposite second end faces the individual storage cells.

In particular when round cells are used, cavities can be arranged between subgroups of storage cells. The individual cavities can each extend from the first end face as far as the second end face of the storage cells. The cavity between the storage cells of each subgroup of storage cells can be delimited by a portion of the lateral surfaces of the storage cells from the subgroup of storage cells. Furthermore, the central axis of the cavity can run precisely through the center of the isosceles triangle formed by the longitudinal axes of the storage cells (when round cells are used).

The individual storage cells can be arranged next to one another in such a manner that the lateral surfaces of directly adjacent storage cells are in contact and/or that no partitions are arranged between the storage cells. Alternatively or additionally, the storage cells can be arranged next to one another in such a manner that gas can circulate between the storage cells. The plurality of storage cells can therefore be arranged next to one another without (gas-tight) partitions in order to bring about as high a packing density of the storage cells as possible in the housing of the energy store.

The housing part described in this document can be part of a housing of the electrical energy store. In this case, the housing can at least partially or completely surround the plurality of storage cells. The housing can have (in addition to the housing part) a housing wall which is designed to (completely) cover the second end faces of the storage cells of the energy store. Furthermore, the housing can have one or more side walls which run along the longitudinal axis of the storage cells and which are designed to shield the plurality of storage cells laterally from the surroundings. Furthermore, the housing can have a cell contacting system (CCS) for electrically contacting the one or more contact points of the plurality of storage cells (e.g. as a housing wall on the first end face of the plurality of storage cells). Furthermore, the housing typically has, on at least one housing wall, at least one degassing valve via which gas can pass from the interior of the housing into the surroundings of the energy store.

The housing part comprises a degassing channel, which is designed to conduct gas to the degassing valve of the energy store. As already stated above, the second end faces of the storage cells (on which the degassing valves of the individual storage cells are arranged) can be aligned with respect to a housing wall (e.g. to the lower housing wall) of the housing of the energy store. The degassing channel can then be arranged between the second end faces of the storage cells and this housing wall.

The housing part furthermore comprises a shielding device, which is designed to cover the common side of the plurality of storage cells (i.e. the second end faces of the storage cells) and thus to shield the common side from gas in the degassing channel. It can thus be reliably brought about that the individual storage cells are not adversely affected by hot gas (e.g. with a temperature of 500° C. or more) and/or by electrically conductive particles in the gas.

Furthermore, the shielding device is designed in such a manner that gas which exits through the degassing valve of a (any) first storage cell of the plurality of storage cells causes and/or produces a locally limited opening in the shielding device, through which the gas from the first storage cell passes into the degassing channel. The locally limited opening can be brought about here as a result of the thermal energy and/or as a result of the pressure of the gas from the first storage cell. The opening is preferably limited to the region of the end face of the first storage cell.

Furthermore, the shielding device is designed in such a manner that the one or more (in particular all) other storage cells of the plurality of storage cells are shielded from the gas from the first storage cell by the shielding device even when the locally limited opening (for gas from the first storage cell) is present.

The housing part therefore has a shielding device which conducts gas selectively from an adversely affected storage cell into the degassing channel of the energy store but which continues to shield the one or more other storage cells of the energy store (which may be directly adjacent to the adversely affected storage cell) from the exiting gas, and thus prevents an adverse effect on the one or more other storage cells. The safety of the energy store can thus be efficiently increased.

The shielding device can comprise a shielding plate, which is designed to cover the common side (i.e. the second end faces) of the plurality of storage cells. Furthermore, the housing part can comprise a housing wall which is arranged parallel to the shielding plate on the side of the shielding plate which faces away from the plurality of storage cells. The degassing channel can then be arranged between the shielding plate and the housing wall. In particular, the degassing channel can be delimited by the shielding plate and the housing wall.

A shielding plate can therefore be used to separate the storage cells (including the cavities between the storage cells) from the degassing channel such that the storage cells and the cavities are shielded from gas in the degassing channel. The shielding device, in particular the shielding plate, can then be designed in such a manner that gas can pass through a locally limited opening (in the shielding plate or in the shielding device) from an adversely affected storage cell into the degassing channel, but cannot pass from there to the other storage cells and/or into the cavities between the storage cells. The safety of the energy store can thus be increased particularly efficiently and reliably.

As already stated further above, the storage cells can each have a (second) end face on the common side. The degassing valve of a storage cell can then be arranged in each case on the (second) end face of the respective storage cell.

The shielding device, in particular the shielding plate, can be designed to seal the end faces of the individual storage cells of the plurality of storage cells from one another and from the degassing channel (substantially) fluid-tightly, in particular (substantially) gas-tightly, if no locally limited opening (for gas from the adversely affected first storage cell) is present. For example, the (second) end faces of the individual storage cells can each be sealed (substantially) fluid-tightly individually (toward the shielding plate) for this purpose.

Furthermore, the shielding device can be designed to seal the end faces of the one or more other storage cells of the plurality of storage cells (substantially) fluid-tightly from one another and from the degassing channel even when the locally limited opening for gas from the (adversely affected) first storage cell is present. In other words, the locally limited opening can be formed in such a manner by the gas exiting from the first storage cell that the other storage cells continue to be shielded (substantially) fluid-tightly from the exiting gas even when the opening is present. An adverse effect on the other storage cells can thus be prevented particularly reliably.

The shielding device can optionally be designed in such a manner that although some of the gas (e.g. 1% or less of the gas) may pass from the degassing channel onto the end face of a storage cell or into the cavity between adjacent storage cells, particles which are contained in the gas in the degassing channel are retained by the shielding device (such that no particles pass onto the end face of the storage cell or into the cavity between adjacent storage cells, in particular particles with a particle size of 50 μm or more).

As already stated above, the plurality of storage cells can be arranged next to one another in such a manner that a cavity which is adjacent to the common side (in particular to the second end faces of the storage cells) is in each case present between subgroups of storage cells. The shielding device can be designed to seal the cavities between the subgroups of storage cells (substantially) fluid-tightly, in particular (substantially) gas-tightly, from the degassing channel and from the end faces of the individual storage cells even when the locally limited opening for gas from the first storage cell is present. Contact between the gas and the lateral surfaces of the storage cells and a resultantly caused adverse effect on the storage cells can thus be reliably prevented.

The shielding device can be designed in such a manner, in particular with respect to the material of the shielding device, that, owing to the thermal energy (e.g. a gas temperature of 500° C. or more) and/or the gas pressure (e.g. 10 bar or more) of the gas exiting from the first storage cell, the locally limited opening is produced, in particular by locally limited melting and/or breaking of the material of the shielding device. On the other hand, the shielding device can be designed in such a manner that, owing to the thermal energy and/or the gas pressure of the gas exiting from the first storage cell, (absolutely) no openings are produced between the degassing valves of the one or more other storage cells and the degassing channel. This can be achieved, for example, by the fact that the gas pressure, after exiting into the degassing channel, has a lower gas pressure and/or a lower temperature than when it exits from the first storage cell (e.g. in each case by the factor of 10 or more).

The shielding device can have a plurality of locally limited predetermined breaking points for the corresponding plurality of storage cells. The predetermined breaking point for a specific storage cell can be designed to selectively form a locally limited opening between the (second) end face of the specific storage cell and the degassing channel as a result of the action of gas from the specific storage cell. The provision of predetermined breaking points for the individual storage cells can make it possible for the locally limited openings to be produced particularly reliably.

The shielding device can have a plurality of coverings, in particular a plurality of pot-shaped coverings, for the corresponding plurality of storage cells. The coverings can be arranged in a corresponding manner to the storage cells of the energy store (e.g. in accordance with a honeycomb mesh structure). The different coverings of the plurality of coverings can be connected to one another via the shielding plate such that a standard component is present.

Optionally, the individual coverings for the individual storage cells can be separate components which, for example, can be arranged next to one another (in accordance with the arrangement of the storage cells) in order to form the covering device. The edges of directly adjacent coverings can optionally be arranged edge-on-edge or overlapping in order to shield the cavity between the directly adjacent storage cells from gas from the degassing channel.

Optionally, the edges of coverings arranged directly next to one another can rest on one another in order to shield the cavity between the corresponding storage cells. In particular, the penetration of particles into the cavity between the storage cells can thus be efficiently avoided.

The covering for a specific storage cell can be designed to seal the (second) end face of the specific storage cell, on which the degassing valve of the specific storage cell is arranged, fluid-tightly from the degassing channel and from the one or more other storage cells of the plurality of storage cells (and from the cavities between the storage cells). For this purpose, the covering can have a profile which corresponds to the shape of the end face of the specific storage cell. The storage cells can each have, for example, a circular or a rectangular end face. The coverings can then each have a corresponding circular or rectangular profile. The provision of individual (pot-shaped) coverings for the individual storage cells makes it possible to shield the individual storage cells particularly reliably from gas from an adversely affected storage cell.

The covering for a specific storage cell can be designed as a pot with a peripheral sealing step onto which the end face of the specific storage cell can be placed in order to seal the end face of the specific storage cell fluid-tightly. The provision of a peripheral sealing step makes it possible to bring about the sealing of the individual storage cells particularly efficiently and reliably. The individual sealing steps can be partially recessed here in the respective pot.

The pot can have a cavity between the peripheral sealing step and the base of the pot. The cavity brings about further shielding of the respective storage cell, thus enabling the safety of the energy store to be increased further.

The pot typically has a (peripheral) side wall between the sealing step and the base. The pot can have, for example, the shape of a truncated cone (circular (for a round cell) or rectangular (for a prismatic cell)). Furthermore, the pot can be designed in such a manner that a locally limited opening is brought about in the side wall as a result of the action of gas from the specific storage cell. A locally limited opening for gas from an adversely affected storage cell can thus be brought about particularly efficiently and reliably.

As already stated above, the housing part can comprise a housing wall which is arranged parallel to the shielding plate. The plurality of coverings can be designed, in particular by means of bases and side walls of the individual coverings, to keep the shielding plate and the housing wall spaced apart from each other such that the degassing channel is formed between the shielding plate and the housing wall. In particular, the shielding device together with the shielding plate and the coverings fastened thereto can be designed as a carrier for the storage cells, wherein the carrier can be placed onto the housing wall, and the degassing channel is thereby formed. A degassing channel can thus be provided particularly efficiently.

According to a further aspect, an electrical energy store is described which comprises a plurality of storage cells which are arranged next to one another in such a manner that degassing valves of the plurality of storage cells are arranged on a common side. The electrical energy store furthermore comprises the housing part described in this document (e.g. in the form of part of a housing of the electrical energy store).

According to a further aspect, a (road) motor vehicle (in particular a passenger vehicle or a truck or a bus or a motorbike) is described which comprises the electrical energy store described in this document.

It should be noted that the devices and systems described in this document can be used both alone and in combination with other devices and systems described in this document. Furthermore, any aspects of the devices and systems described in this document can be combined with one another in a variety of ways. In particular, the features of the claims can be combined with one another in a variety of ways.

The invention is described in greater detail below with reference to exemplary embodiments.

### BRIEF DESCRIPTION OF THE DRAWINGS

FIG. 1 shows an exemplary vehicle with an electrical energy store;

FIG. 2a shows an exemplary round cell;

FIG. 2b shows an exemplary electrical energy store with a multiplicity of round cells;

FIG. 3a shows an exemplary housing part for an electrical energy store for conducting gas out of a storage cell;

FIG. 3b shows the housing part from FIG. 3a in a view from below of the planar shielding device; and

FIGS. 4a to 4d show different views of a shielding device with pots for the individual storage cells of the energy store.

### DETAILED DESCRIPTION OF THE DRAWINGS

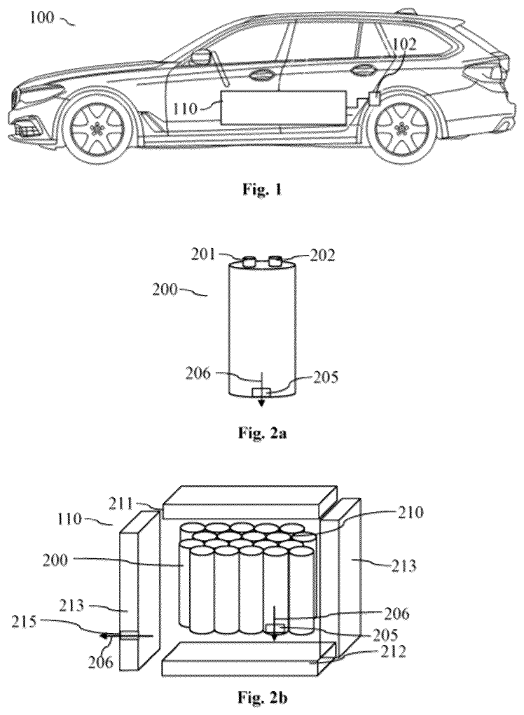

As stated at the beginning, the present document deals with the efficient and safe conducting of gas out of a storage cell of an electrical energy store. In this connection, FIG. 1 shows an exemplary vehicle 100 with an electrical energy store 110 which is designed to store electrical energy for the operation of an electric drive motor 102 of the vehicle 100. The electrical energy store 110 can have, for example, a nominal voltage of 300V or more and/or a nominal storage capacity of 10 kWh or more.

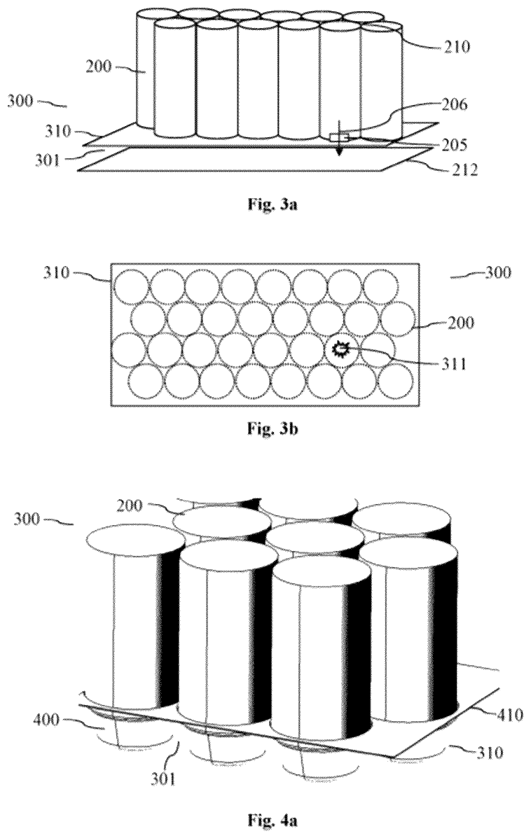

FIG. 2a shows an exemplary storage cell 200, in particular a round cell, for an electrical energy store 110. The storage cell 200 has a circular-cylindrical shape. A positive contact point 201 and a negative contact point 202 for the electrical connection of the storage cell 200 are arranged on a first end face of the storage cell 200. The storage cell 200 furthermore has a degassing valve 205 (e.g. on the opposite second end face of the storage cell 200) via which gas 206 containing particles, which may be produced in the event of an exothermic reaction in the storage cell 200, can be conducted out of the interior of the storage cell 200.

FIG. 2b shows an exemplary electrical energy store 110 which has a multiplicity of storage cells 200 which are arranged next to one another side-by-side, in particular in such a manner that the contact points 201, 202 of the individual storage cells 200 are arranged on a standard side (on the top side in FIG. 2b). The energy store 110 can have, for example, 50 or more storage cells 200, or 1000 or more storage cells 200.

The individual storage cells 200 can be electrically conductively connected to one another via a cell contacting system 211. The cell contacting system 211 can have, for example, a frame with connecting lines for electrically contacting the contact points 201, 202 of the individual storage cells 200. The cell contacting system 211 can be arranged on that side of the storage cells 200 on which the contact points 201, 202 of the storage cells 200 are also arranged. A housing wall 212 of a housing of the energy store 110 can be arranged on the opposite side of the storage cells 200, e.g. on the side with the degassing valves 205. The opposite housing wall 212 can be designed, for example, as a cooling plate for cooling the individual storage cells 200.

The housing of the electrical energy store 110 can be formed, for example, by the cell contacting system 211, by the opposite housing wall at 212 and by one or more side walls 213. The storage cells 200 can optionally be enclosed completely, in particular fluid-tightly, by the housing. The housing of the electrical energy store 110 can have a degassing valve 215 (e.g. in a side wall 213) via which gas 206 from a storage cell 200 can be conducted into the environment of the electrical energy store 110.

As illustrated in FIG. 2b, the (circular-cylindrical) storage cells 200 can be arranged in such a manner that the lateral surfaces of directly adjacent storage cells 200 are in contact. Cavities 210 are produced between subgroups of storage cells 200, which cavities can extend, for example, along the longitudinal axis of the storage cells 200 from the first side or end face (with the cell contacting system 211) to the second side or end face (with the opposite housing wall 212) of the individual storage cells 200.

If gas 206 exits from a storage cell 200, the gas 206 may first be distributed in the interior of the housing of the energy store 110 before the gas 206 is guided out of the housing of the energy store 110 via the degassing valve 215. The hot gas 206 can cause the other storage cells 200 to heat up and thus be thermally loaded. Furthermore, the (electrically conductive) particles entrained by the gas 206 may lead to an increased risk of short-circuits in and/or between the other storage cells 200.

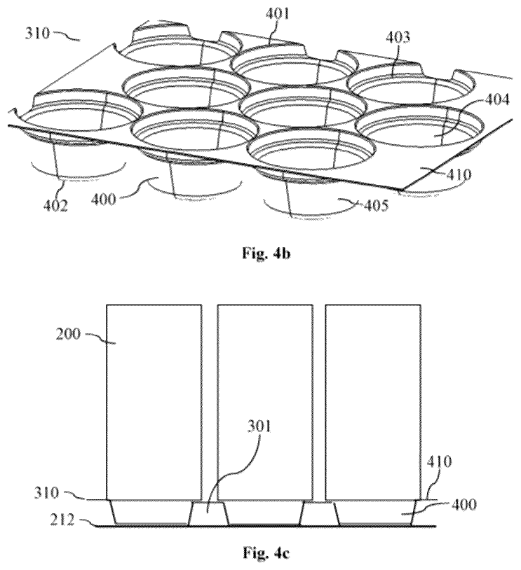

The housing or housing part 300 illustrated in FIGS. 3a and 3b for an electrical energy store 110 comprises a shielding device 310 which is designed to shield the gas 206 exiting from a storage cell 200 via the degassing valve 205 of the storage cell 200 from the other storage cells 200 of the energy store 110. This in particular has the effect that the gas 206 cannot pass into the cavities 210 between the storage cells 200. The loading and the short-circuit risk of the storage cells 200 can thus be reliably reduced.

Furthermore, the shielding device 310 is designed to conduct the exiting gas 206 into a degassing channel 301 via which the gas 206 is guided to the degassing valve 215 of the energy store 110 in order to be conducted out of the housing of the energy store 110 without the gas 206 coming into contact with the other storage cells 200. In the example illustrated in FIG. 3a, the degassing channel 301 is arranged in an intermediate space between the shielding device 310 and the housing wall 212 opposite the cell contacting system 211.

As illustrated in FIGS. 3a and 3b, the shielding device 310 can be designed as a plate which is connected fixedly and fluid-tightly to the (second) end faces of the storage cells 200. Furthermore, the shielding device 310, in particular the shielding plate, can be designed to form, by action of the gas 206 from an adversely affected storage cell 200, a local and/or locally limited opening 311 through the shielding device 310 in the region of the adversely affected storage cell 200. The gas 206 can act on the shielding device 310 thermally (i.e. by means of thermal energy) and/or by means of pressure in the region of the degassing valve 205 of the adversely affected storage cell 200. For example, the material of the shielding device 310 can be designed in such a manner that the material melts and/or breaks because of the action of the gas 206, in order to form the opening 311.

The opening 311 in the shielding device 310 brought about by the gas 206 exiting from the adversely affected storage cell 200 is limited locally to the adversely affected storage cell 200 in such a manner that the shielding device 310 continues to shield the other adjacent storage cells 200 (and the cavities 210 between the storage cells 200) from the gas 206 and/or from the degassing channel 301.

The gas 206 emerging from the adversely affected storage cell 200 can then pass through the opening 311 in the shielding device 310 into the degassing channel 301 and from there to the degassing valve 215 of the energy store 110.

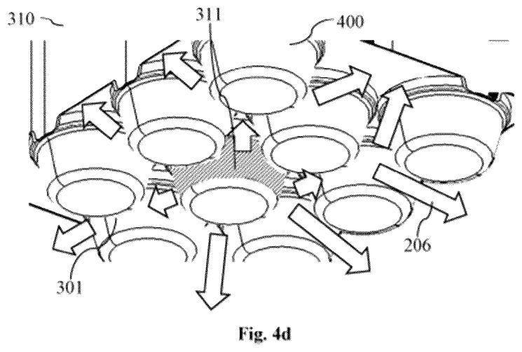

FIGS. 4a to 4d illustrate a shielding device 310 which, for the individual storage cells 200 of the energy store 110, in each case has a pot 400 into which the respective storage cell 200 can be placed. The shielding device 310 can thus be efficiently used as a positioning aid for the arrangement of the individual storage cells 200 during the installation of the energy store 110.

The shielding device 310 can have a shielding plate 410 on which the multiplicity of pots 400 for the corresponding multiplicity of storage cells 200 is arranged. The shielding plate 410 can connect the upper edges 401 of the individual pots 400 to one another. The bases 402 of the individual pots 400 can be designed to be supported against a housing wall 212 of the housing of the energy store 110. The degassing channel 301 for the gas 206 from an adversely affected storage cell 200 is then formed between the outer walls of the pots 400 and the housing wall 212.

The shielding plate 410 can optionally have cooling designed to cool the multiplicity of storage cells 200 (in particular whenever the shielding plate 410 covers the end faces of the multiplicity of storage cells 200, as illustrated in FIG. 3a (the shielding plate 410 being identified there by the reference sign 310)).

A pot 400 can be designed in such a manner that the pot 400 below the upper edge 401 and above the base 402 has a sealing step 403 onto which the end face of a storage cell 200 can be placed, in particular in such a manner that a (preferably (substantially) gas-tight) cavity 404 is formed between the end face of the storage cell 200 and the base 402 of the pot 400. This cavity 404 constitutes an additional shielding of a storage cell 200 from gas 206 within the degassing channel 301.

FIG. 4b shows pots 400 each having a sealing step 403 for depositing a storage cell 200. In the example illustrated in FIG. 4c, the storage cells 200 stand directly on the shielding plate 410.

A pot 400, in particular the side wall 405 of a pot 400, can be designed in such a manner that, in the event of action of the gas 206 exiting from the storage cell 200 placed in or above the pot 400, an opening 311 is formed through which the gas 206 from the adversely affected storage cell 200 passes into the degassing channel 301. This is illustrated by way of example in FIG. 4d by the arrows.

An energy store 110 can thus have, below the cells 200, a structural component 310 (i.e. a shielding device) which connects the cells 200 in a planar manner to the housing base 212 of the housing of the energy store 110 and can transmit forces, and is optionally deformed in the event of local impacts in order to prevent damage to the cells 200. The structural component 310 can be produced from plastic and/or from a non-conductive material. The structural strength can be produced by forming (round or hexagonal or rectangular) pots 400 with a certain wall thickness and/or with certain geometries and/or ribs.

The individual pots 400 can be arranged in such a manner that one pot 400 is arranged under each cell 200. The wall 405 of the individual pots 400 can be peripherally closed in such a manner that if gas exits from one cell 200 it is prevented from flowing around adjacent cells 200.

The individual cells 200 can be adhesively bonded into the structural component 310, in particular into the individual pots 400, or adhesively bonded onto the structural component 310. A closed pot 400 (e.g. a truncated cone) can be arranged under each cell 200, with the bases 402 of the pots 400 being able to be connected to a housing wall 212 of the housing of the energy store 110.

If emergency degassing occurs in a cell 200 (e.g. because of a cell short-circuit or because of a thermal event), the walls 405 of the pot 400 of the cell 200 concerned are torn open by the pressure and/or heat of the gas 206 (e.g. as a type of bursting membrane). The gas 206 then passes into the one or more degassing channels 301 as far as the emergency degassing opening 215 of the energy store 110. Since the pressure and the temperature of the gas 206 in the one or more degassing channels 301 are typically lower than at the degassing valve 205 of the cell 200 concerned, the walls 405 of the pots 400 of the other cells 200 are not perforated. Consequently, all of the further cells 200 are protected from the hot gas 206 containing the conductive particles from the cell 200 concerned, as a result of which the safety of the energy store 110 can be efficiently increased.

The present invention is not restricted to the exemplary embodiments shown. It should be noted, in particular, that the description and the figures are intended to illustrate the principle of the proposed devices and systems only by way of example.

1-14. (canceled)

15. A housing part for an electrical energy store which has a plurality of storage cells arranged next to one another such that degassing valves of the plurality of storage cells are arranged on a common side, the housing part comprising:
a degassing channel which is configured to conduct gas to at least one degassing valve of the energy store; and
a shielding device configured to cover the common side of the plurality of storage cells in order to shield the common side from gas in the degassing channel,
the shielding device being further configured such that:
gas which exits through the degassing valve of a first storage cell of the plurality of storage cells causes a locally limited opening in the shielding device, through which the gas from the first storage cell passes into the degassing channel; and
the one or more other storage cells of the plurality of storage cells are shielded from the gas from the first storage cell by the shielding device even when the locally limited opening is present.

16. The housing part according to claim 15, wherein
the shielding device comprises a shielding plate, which is configured to cover the common side of the plurality of storage cells.
the housing part comprises a housing wall which is arranged parallel to the shielding plate on a side of the shielding plate that faces away from the plurality of storage cells,
the degassing channel is arranged between the shielding plate and the housing wall, and
the degassing channel is delimited by the shielding plate and the housing wall.

17. The housing part according to claim 15, wherein
the plurality of storage cells each have an end face on the common side,
the degassing valve of a storage cell is arranged on the end face of the respective storage cell,
the shielding device is configured to seal the end faces of the individual storage cells of the plurality of storage cells from one another and from the degassing channel substantially fluid-tightly when no locally limited opening is present, and
the shielding device is configured to seal the end faces of the one or more other storage cells of the plurality of storage cells substantially fluid-tightly from one another and from the degassing channel even when the locally limited opening for gas from the first storage cell is present.

18. The housing part according to claim 17, wherein
the plurality of storage cells are arranged next to one another such that a cavity which is adjacent to the common side is in each case present between subgroups of the plurality of storage cells,
the shielding device is configured to seal the cavities between the subgroups fluid-tightly from the degassing channel and from the end faces of the individual storage cells even when the locally limited opening for gas from the first storage cell is present.

19. The housing part according to claim 15, wherein
the shielding device is configured with respect to a material of the shielding device, such that, owing to thermal energy and/or gas pressure of the gas exiting from the first storage cell, the locally limited opening is produced, by locally limited melting and/or breaking of the material of the shielding device.

20. The housing part according to claim 19, wherein
the shielding device is configured such that, owing to the thermal energy and/or the gas pressure of the gas exiting from the first storage cell, no openings are produced between the degassing valves of the one or more other storage cells and the degassing channel.

21. The housing part according to claim 15, wherein
the shielding device has a plurality of locally limited predetermined breaking points for the corresponding plurality of storage cells, and
a predetermined breaking point for a specific storage cell is designed to selectively form a locally limited opening between an end face of the specific storage cell and the degassing channel as a result of an action of gas from the specific storage cell.

22. The housing part according to claim 15, wherein
the shielding device has a plurality of pot-shaped coverings for the corresponding plurality of storage cells, and
a covering for a specific storage cell is designed to seal an end face of the specific storage cell, on which the degassing valve of the specific storage cell is arranged, fluid-tightly from the degassing channel and from the one or more other storage cells of the plurality of storage cells.

23. The housing part according to claim 22, wherein
the covering for a specific storage cell is configured as a pot with a peripheral sealing step onto which the end face of the specific storage cell is placable in order to seal the end face of the specific storage cell fluid-tightly, and
the pot has a cavity between the peripheral sealing step and a base of the pot.

24. The housing part according to claim 23, wherein
the pot has a side wall between the sealing step and the base, and
the pot is configured such that a locally limited opening is brought about in the side wall as a result of an action of gas from the specific storage cell.

25. The housing part according to claim 22, wherein
the shielding device has a shielding plate, and
the plurality of coverings are connected to one another via the shielding plate.

26. The housing part according to claim 25, wherein
the housing part comprises a housing wall which is arranged parallel to the shielding plate, and
the plurality of coverings are configured, via bases and side walls of the individual coverings, to maintain the shielding plate and the housing wall spaced apart from each other such that the degassing channel is formed between the shielding plate and the housing wall.

27. The housing part according to claim 23, wherein
the storage cells of the plurality of storage cells each have a circular or rectangular end face, and
the coverings of the plurality of coverings each have a corresponding circular or rectangular profile.

28. An electrical energy store, comprising:
a plurality of storage cells which are arranged next to one another such that degassing valves of the plurality of storage cells are arranged on a common side; and
a housing with a degassing valve, wherein a housing part of the housing comprises:
a degassing channel configured to conduct gas to the degassing valve of the housing; and
a shielding device configured to cover the common side of the plurality of storage cells in order to shield the common side from gas in the degassing channel,
wherein the shielding device is further configured such that:
gas which exits through the degassing valve of a first storage cell of the plurality of storage cells causes a locally limited opening in the shielding device, through which the gas from the first storage cell passes into the degassing channel; and
one or more other storage cells of the plurality of storage cells are shielded from the gas from the first storage cell by the shielding device even when the locally limited opening is present.
